(19) United States
(12) Patent Application Publication
(10) Pub. No.: US 2016/0214131 A1
(43) Pub. Date: Jul. 28, 2016

(54) REFILLABLE AND PORTABLE DISTRIBUTOR, INSTALLER, APPLICATION FOR CREAM

(71) Applicant: AXILONE PLASTIQUE, Auray (FR)

(72) Inventors: Mathilde GATESOUPE, Guidel (FR); Eric GUILLOU, Saint Philibert (FR)

(21) Appl. No.: 14/904,348

(22) PCT Filed: Jul. 8, 2014
(86) PCT No.: PCT/FR2014/051748

§ 371 Date: Jan. 11, 2016

(30) Foreign Application Priority Data
Jul. 10, 2013 (FR) 13 56792

(51) Int. Cl. B67D 7/06; A45D 40/26; B05B 11/00; A45D 40/00

(52) U.S. Cl. CPC B05B 11/3074; A45D 40/0075; A45D 40/262; B05B 11/0054; B05B 11/3001

(57) ABSTRACT

A portable refillable cream dispenser, positioning device and applicator, which includes a first body/actuation/dispensing-deposition-application assembly, having a first body, a dispensing-deposition-application head slidably mounted in the first body between a proximal position and a distal position, with a passage having an upstream seat and a downstream dispensing-deposition-application unit, an actuation unit mounted so as to be able to move with respect to the first body between a proximal position and a distal position, a resilient unit capable of urging the dispensing-deposition-application head and the actuation unit, toward the proximal position thereof, and capable of being compressed when same are in the distal position thereof; and a second body/refill assembly including a second body, a refill with a reservoir and a unit having a pump and an actuation tube; the first body/actuation/dispensing-deposition-application assembly and the second body including additional rigid and detachable connecting devices.

### FIELD OF THE INVENTION

The invention relates to the field of portable refillable cream dispensers, depositing devices, and applicators, typically those for cosmetic, medical, or functional use.

The invention more particularly relates to a portable refillable cream dispenser, depositing device, applicator comprising a first body/actuation/dispensing-deposition-application assembly and a second body/refill assembly with a refill comprising a reservoir filled with cream to be dispensed, such a first body/actuation/dispensing-deposition-application assembly and such a second body/refill assembly, specifically intended for such a portable refillable cream dispenser, depositing device, applicator without refill, and, lastly, a compound assembly comprising such a portable refillable cream dispenser, depositing device, applicator without refill and a plurality of cream refills, each for a specific cream.

### BACKGROUND OF THE INVENTION

The field of the invention is typically that of portable refillable cream dispensers, depositing devices, applicators for purse, pocket, and/or travel, these terms being provided by way of example, of a capacity of between about 15 ml and about 100 ml. As an illustration, such a portable refillable cream dispenser, depositing device, applicator typically has an axial length of between about 50 mm and about 150 mm, and a diameter between about 20 mm and about 60 mm. With the portable refillable cream dispensers, depositing devices, applicators of the general field of the invention, the amount of cream dispensed, deposited, applied when pressure is exerted is about 0.08 ml to 0.5 ml.

Document WO 2013/014626 discloses a portable refillable cream dispenser, depositing device, applicator which comprises a refill mechanism for refilling from a source of cream. Such an implementation is complex and inappropriate when the refill needs to be done simply and quickly, such as in the field of cosmetics.

Refillable spray units are also known which comprise a valve device that allows filling the reservoir with the liquid to be sprayed, when it is empty. However, such an embodiment, possible with contents of low viscosity such as a liquid for a fragrance, cologne, toilet water . . . to be sprayed, cannot be considered for any content of high viscosity, such as skin cream, which cannot be sprayed but must be dispensed, deposited, applied.

The invention aims to solve these problems.

### SUMMARY OF THE INVENTION

A description of the invention is provided below.

According to a first aspect, the invention relates to a portable refillable cream dispenser, depositing device, applicator, comprising parts that are mechanically associated so as to be integrally attached and fluidly associated so that the cream of a reservoir can be dispensed, deposited, applied following a maneuvering of an actuation means.

This portable refillable cream dispenser, depositing device, applicator has the following characteristics:
a first body/actuation/dispensing-deposition-application assembly, extending axially, comprising:
   a first elongate body having a proximal end portion and a distal end portion with a transverse mounting opening,
   a dispensing-deposition-application head mounted so as to slide axially within the first body towards its proximal end portion provided with an outlet opening, with a wall portion to which leads a dispensing-deposition-application means appropriate for dispensing, depositing, applying cream, between a proximal position with no dispensing-deposition-application and a distal position with dispensing-deposition-application, with an interior passage having a distal upstream seat and the proximal downstream dispensing-deposition-application means,
   an actuation means mounted so as to be movable relative to the first body towards its proximal end portion provided with an actuation opening, between an inactive proximal position and an active distal position, able to be actuated by the user, with subsequent sliding of the dispensing-deposition-application head,
   a resilient means urging the dispensing-deposition-application head and the actuation means towards their proximal position, and capable of being compressed when the dispensing-deposition-application head and the actuation means are in their distal position,
a second body/refill assembly, extending axially, comprising:
   a second body,
   a refill of cream, comprising: a reservoir having a distal end portion cooperating with a receiving portion of the second body and a proximal end portion with an opening, and a means with pump and actuation tube, mounted in the reservoir opening, the actuation tube extending the reservoir in the proximal direction and having an end connection portion for connecting with the seat,
the first body/actuation/dispensing-deposition-application assembly and the second body comprising complementary rigid and detachable connection members,
the seat and the connection portion of the actuation tube being connected by mutual contact of respective contact faces, with sealing means.

In one embodiment, the first assembly further comprises an element for axially guiding the refill during assembly of the dispenser, depositing device, applicator, in particular for axially guiding the connection portion of the actuation tube relative to the seat of the dispensing-deposition-application head.

In one embodiment, the first assembly comprises an elongate tubular spring, arranged in the first body, having a proximal end portion bearing axially against the dispensing-deposition-application head and actuation means, so as to urge them towards their proximal position, and a distal end portion with a transverse mounting opening, the tubular spring and the first body comprising complementary axial locking stops to retain the tubular spring in the first body, the tubular spring having a combination of general stability and a capacity to be compressed axially, allowing it to be compressed when the dispensing-deposition-application head and actuation means are in their proximal position. In one embodiment, the reservoir and the tubular spring respectively have cylindrical outer and inner faces of the same diameter (with some clearance for assembly), so as to form an element that axially guides the refill during assembly of the dispenser, depositing device, applicator. In one embodiment, the tubular spring extends axially in the distal direction, such that its mounting opening is only slightly distanced axially from the mounting opening of the first body.

In one embodiment, the rigid and detachable connection members of the first assembly are provided on the first body, such as rigid and detachable connection members which are mechanical or magnetic.

In one embodiment, the sealing means between the seat of the dispensing-deposition-application head and the connection portion of the actuation tube comprise a dimensional adjustment of their respective contact faces, this contact with dimensional adjustment being suitable for ensuring the required fluidtightness between the seat and the connection portion of the actuation tube, where appropriate with the reliefs and/or surface finishes of the contact faces contributing to the fluidtightness. In one embodiment, said dimensional adjustment is suitable for allowing—during assembly or disassembly of the portable refillable cream dispenser, depositing device, applicator—a relative axial sliding of said contact faces, having a general shape that is either cylindrical and axial or flat and transversal.

In one embodiment, the dispensing-deposition-application head with its passage, seat, and dispensing-deposition-application means and actuation means, form a single functional unit axially mounted on the first body, comprising a wall portion shaped for the dispensing, deposition, application of cream, to which leads, in particular medially, the dispensing-deposition-application means and which forms the actuation means, while the first body comprises a transverse outlet and actuation opening.

In one embodiment, the dispensing-deposition-application means leads to a wall portion free of sharp edges and of areas that would tend to retain cream.

In the embodiments, the dispensing-deposition-application means is a tube, nozzle, applicator pad, or brush.

In one embodiment, the refill comprising the reservoir and the means with pump and actuation tube is detachably mounted in the receiving portion of the second body.

In one embodiment, the refill has a capacity of between about 15 ml and about 100 ml. In one embodiment, the portable refillable cream dispenser, depositing device, applicator has an axial length of between about 50 mm and about 150 mm, and a diameter of between about 20 mm and about 60 mm. In one embodiment, the amount of cream dispensed, deposited, applied when pressure is exerted on the actuation means is about 0.08 ml to 0.5 ml.

In one embodiment, the reservoir and the means with pump and actuation tube form an inseparable whole which is the cream refill.

In one configuration, the portable refillable cream dispenser, depositing device, applicator comprises a refill filled with cream.

According to a second aspect, the invention provides a first body/actuation/dispensing-deposition-application assembly, specifically intended for a portable refillable cream dispenser, depositing device, applicator as was described, and for connection to a second body/refill assembly for the latter, comprising, with an axis:
an elongate first body having a proximal end portion and distal end portion with a transverse mounting opening,
   a dispensing-deposition-application head mounted so as to slide axially within the first body towards its proximal end portion provided with an outlet opening, with a wall portion to which leads a dispensing-deposition-application means shaped for the dispensing, deposition, application of cream, between a proximal position with no dispensing-deposition-application and a distal position with dispensing-deposition-application, with an interior passage having a distal upstream seat and the proximal downstream dispensing-deposition-application means,
an actuation means mounted so as to be movable relative to the first body towards its proximal end portion provided with an actuation opening, between an inactive proximal position and an active distal position, able to be actuated by the user, with subsequent sliding of the dispensing-deposition-application head,
a resilient means urging the dispensing-deposition-application head and actuation means towards their proximal position, and capable of being compressed when the dispensing-deposition-application head and actuation means are in their distal position,
a rigid and detachable connection member, complementary to a rigid and detachable connection member of the second body of the second body/refill assembly.

In one embodiment, the first assembly comprises an axially guiding tubular spring, suitable and intended for axially guiding the refill during assembly of the dispenser, depositing device, applicator, which is axially elongate and arranged within the first body, having a proximal end portion bearing axially against the dispensing-deposition-application head and actuation means, and a distal end portion with a transverse mounting opening, the axially guiding tubular spring and the first body comprising complementary axial locking stops to retain the axially guiding tubular spring in the first body, the axially guiding tubular spring having a combination of general stability and a capacity to be compressed axially, the axially guiding tubular spring extending axially in the distal direction, such that its mounting opening is only slightly distanced axially from the mounting opening of the first body.

In one embodiment, the first assembly comprises sealing means associated with the seat, for fluidtightness between the seat and the connection portion of the actuation tube, comprising the dimensional adjustment of the contact face of the seat suitable and intended to be in mutual contact with a contact face of the connection portion of the actuation tube, this contact with dimensional adjustment being suitable for ensuring the required fluidtightness between the seat and the connection portion of the actuation tube, where appropriate with the reliefs and/or surface finishes of the contact face of the seat contributing to the fluidtightness.

In one embodiment, the first assembly is such that the contact face of the seat has a general shape that is either cylindrical and axial or flat and transversal.

According to a third aspect, the invention relates to a second body/refill assembly, specifically intended for a portable refillable cream dispenser, depositing device, applicator as described above, and to be connected to a first body/actuation/dispensing-deposition-application assembly of the dispenser, depositing device, applicator as described above, comprising, with an axis:
a second body having a receiving portion,
a cream refill, comprising: a reservoir having a distal end portion cooperating with a receiving portion of the second body and a proximal end portion with an opening, and a means with pump and actuation tube, mounted in the reservoir opening, the actuation tube extending the reservoir in the proximal direction and having an end connection portion for connecting with a seat of the first body/actuation/dispensing-deposition-application assembly,
a rigid and detachable connection member, complementary to a rigid and detachable member of the first body/actuation/dispensing-deposition-application assembly.

In one embodiment, the second assembly comprises sealing means associated with the connection portion of the actuation tube, for fluidtightness between the connection portion of the actuation tube and the seat, comprising the dimensional adjustment of the contact face of the connection portion of the actuation tube suitable and intended to be in mutual contact with a contact face of the seat, this contact with dimensional adjustment being suitable for ensuring the required fluidtightness between the connection portion of the actuation tube and the seat, where appropriate with the reliefs and/or surface finishes of the contact face of the connection portion of the actuation tube contributing to the fluidtightness.

According to a fourth aspect, the invention relates to a portable refillable cream dispenser, depositing device, applicator, without refill, comprising a first body/actuation/dispensing-deposition-application assembly as was described, and a second body suitable and intended to be part of a second body/refill assembly as was described, the first body/actuation/dispensing-deposition-application assembly and the second body being suitable and intended for rigid and detachable interconnection with their complementary rigid and detachable connection members.

According to a fifth aspect, the invention relates to a dispensing-deposition-application compound assembly, comprising a portable refillable cream dispenser, depositing device, applicator without refill as was described, and a plurality of cream refills, each for a specific cream.

### BRIEF DESCRIPTION OF THE DRAWINGS

The figures of the drawings are now briefly described.

FIG. 1 is an axial section view of a complete portable refillable cream dispenser, depositing device, applicator, comprising a first body/actuation/dispensing-deposition-application assembly and a second body/refill assembly connected to one another, wherein the dispensing-deposition-application head and the actuation means are in the proximal position with no dispensing-deposition-application, the first assembly comprises a tubular spring which axially guides the refill during assembly of the portable refillable cream dispenser, depositing device, applicator, and the second body/refill assembly comprises a second body and a cream refill.

FIG. 2 is a view similar to FIG. 1, but with the dispensing-deposition-application head and the actuation means in the distal position with dispensing-deposition-application.

FIG. 3 is a view similar to FIG. 1, but of the first assembly alone.

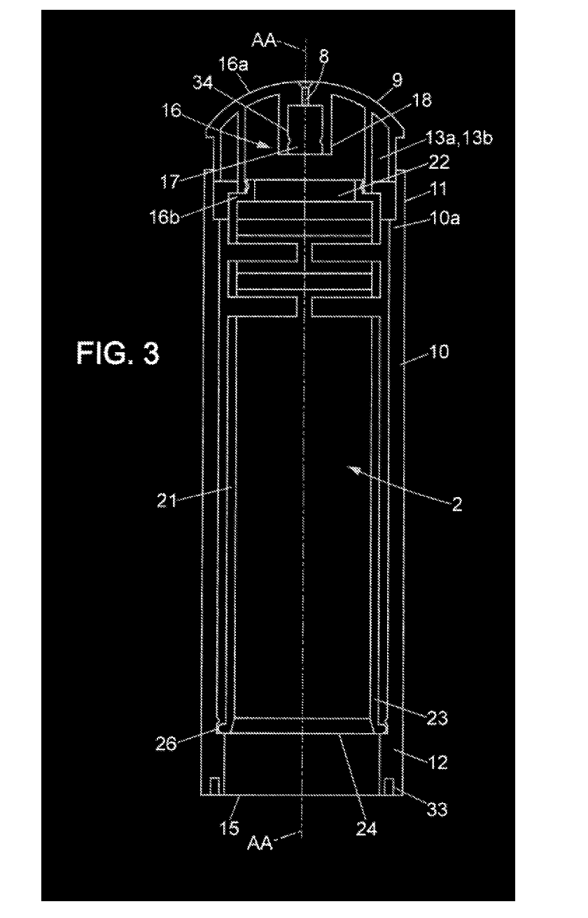

FIG. 4 is a view similar to FIG. 1, but of the second assembly alone.

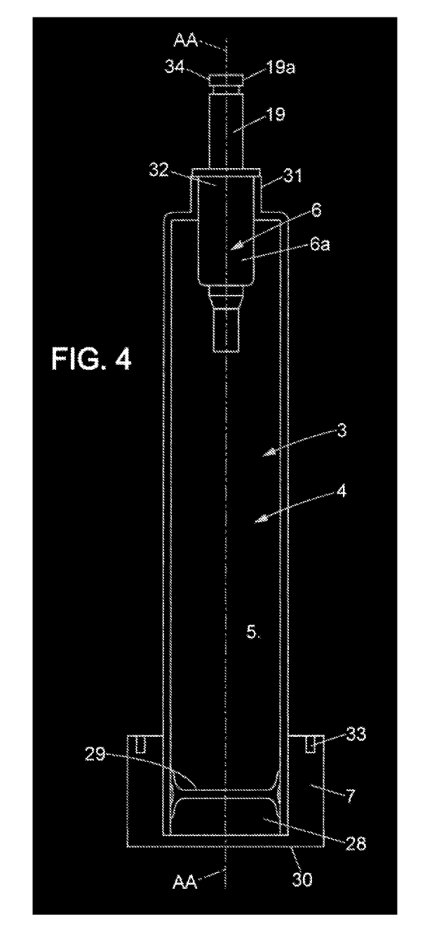

FIG. 5 is a view similar to FIG. 1, of the first assembly and the second body, but not of the cream refill, forming a portable refillable cream dispenser, depositing device, applicator without refill.

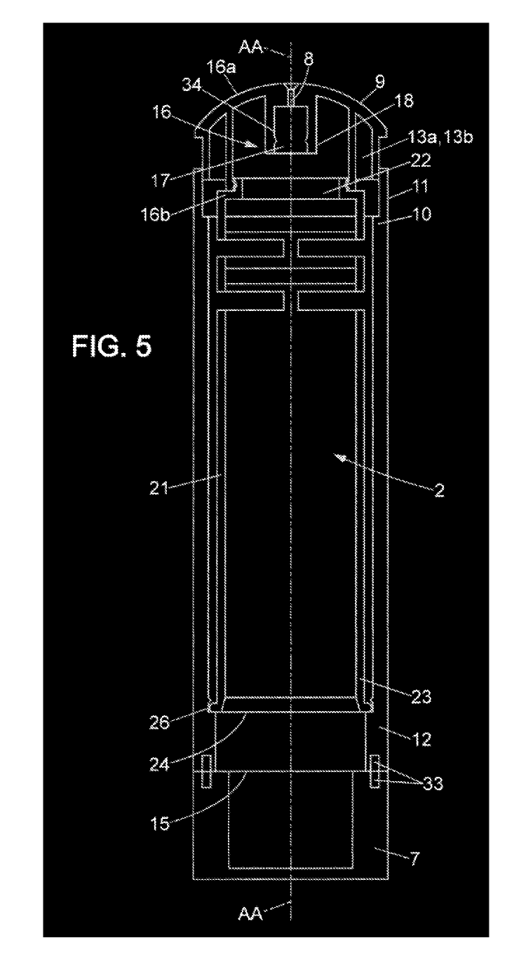

### DETAILED DESCRIPTION

Below is a detailed account of several embodiments of the invention, accompanied by examples and with reference to the drawings.

A portable refillable cream dispenser, depositing device, applicator 1, according to the invention, is typically a portable refillable cream dispenser, depositing device, applicator for purse, pocket, and/or travel, these terms being provided by way of example. Such a portable refillable cream dispenser, depositing device, applicator has a capacity of between about 15 ml and about 100 ml. As an illustration, such a portable refillable cream dispenser, depositing device, applicator 1 may have an axial length of between about 50 mm and about 150 mm, and a diameter of between about 20 mm and about 60 mm, the amount of cream distributed, deposited, applied when pressure is exerted being about 0.08 ml to 0.5 ml.

A portable refillable cream dispenser, depositing device, applicator 1 according to the invention, complete and able to distribute, deposit, apply a cream, such as a cosmetic, medical, or functional cream, comprises a first body/actuation/dispensing-deposition-application assembly 2 and a second body/refill assembly 3 which includes a cream refill 4 which itself comprises a reservoir 5, suitable for receiving cream to be sprayed, and a means 6 with pump 6a and actuation tube 19 having a proximal end connection portion 19a.

The invention relates to the portable refillable cream dispenser, depositing device, applicator 1, whether or not the reservoir 5 is filled with cream, as well as to the first body/actuation/dispensing-deposition-application assembly 2, to the second body/refill assembly 3, each considered in and of itself as intended to be part of such a portable refillable cream dispenser, depositing device, applicator 1, to the portable refillable cream dispenser, depositing device, applicator without refill, and lastly, to a compound cream dispensing-deposition-application assembly, comprising such a portable refillable cream dispenser, depositing device, applicator without refill and several cream refills 4, each for a specific cream.

For simplification, the description is given specifically with reference to a portable refillable cream dispenser, depositing device, applicator 1 that is complete, the first body/actuation/dispensing-deposition-application assembly 2 and the second body/refill assembly 3 being connected, it being understood, however, that the first body/actuation/dispensing-deposition-application assembly 2 as well as the second body/refill assembly 3 can be structurally separated from each other, and that the second body/refill assembly 3 may comprise the cream refill 4 or be without it, said cream refill 4 itself possibly structurally detached from the second body/refill assembly 3 and the portable refillable cream dispenser, depositing device, applicator 1.

The portable refillable cream dispenser, depositing device, applicator 1 comprises an axis AA which is the axis common to the first body/actuation/dispensing-deposition-application assembly 2 and to the second body/refill assembly 3, and which is the axis of each of these assemblies 2, 3, each considered per se, and which is also the axis of each of the component parts of these assemblies 2, 3. The portable refillable cream dispenser, depositing device, applicator 1 as well as the first body/actuation/dispensing-deposition-application assembly 2 and the second body/refill assembly 3, and each of their component parts, have a generally cylindrical or pseudo-cylindrical shape with a circular or pseudo-circular cross-section.

In the portable refillable cream dispenser, depositing device, applicator 1, the first body/actuation/dispensing-deposition-application assembly 2 and the second body/refill assembly 3—especially the second body 7—are, by means of their component parts, mechanically connected so as to be rigidly but detachably secured—then detached, with the possibility of reattachment, such attachments and detachments being possible as many times as desired and for as long as desired.

They are also in fluid association, so that the cream of a reservoir 5 can be distributed, deposited, applied by a dispensing-deposition-application means, subsequent to actuation of an actuation means 9.

We will now describe the first body/actuation/dispensing-deposition-application assembly 2, having axis AA.

The first body/actuation/dispensing-deposition-application assembly 2 firstly comprises a rigid and hollow elongate first body 10, extending between a proximal end portion 11 and a distal end portion 12.

The term “proximal” refers to what is closest to or facing the dispensing-deposition-application area, and applies to the portable refillable cream dispenser, depositing device, applicator 1, to the first body/actuation/dispensing-deposition-application assembly 2, to the second body/refill assembly 3, and to their component parts. The term “distal” refers to what is furthest from or facing away from the dispensing-deposition-application area, and also applies to the portable refillable cream dispenser, depositing device, applicator 1, to the first body/actuation/dispensing-deposition-application assembly 2, to the second body/refill assembly 3, and to their component parts.

In the embodiment shown, the proximal end portion 11 is provided with an outlet opening 13a and with an actuation opening 13b which together form a single transverse opening 13a, 13b. This implementation is not exclusive of others in which the outlet opening 13a and the actuation opening 13b are distinct without necessarily being arranged transversely.

The term “transverse” refers to what is transaxial to axis AA, in particular orthogonally or the like.

The term “opening” is to be understood in its most general sense, including for example a notch.

The outlet opening 13a is formed to be suitable for the function of dispensing, depositing, applying cream, which is the object of the dispenser, depositing device, applicator 1, according to the nature, shape, size, and requirements of the dispensing-deposition-application means 8.

For example, as illustrated by the figures, the outlet opening 13a is transversal, and its shape transversely is a shape complementary to that of a dispensing-deposition-application head 16 comprising the dispensing-deposition-application means 8 suitable for an axial release of cream, of which the proximal wall 16a, extending generally transversely, has a curved outer face of a convexity directed axially outwardly of the dispenser, depositing device, applicator 1, so as to allow contact with the surface receiving the cream (such as the skin in the case of a cosmetic or moisturizing cream) similarly to a ball head. Thus, the proximal wall 16a or a portion of the proximal wall 16a of the dispensing-deposition-application head 16 to which the dispensing-deposition-application means 8 leads, here medial, itself is also shaped to be suitable for the function of dispensing, depositing, applying cream, of the dispenser, depositing device, applicator 1.

This embodiment is not exclusive of others in which the proximal wall 16a of the dispensing-deposition-application head 16 has an outer face of a concavity directed axially outwardly of the dispenser, depositing device, applicator 1 so as to be able to fit against a large area of the surface receiving the cream, itself curved, in the manner of a surface applicator. Alternatively, the proximal wall 16a of the dispensing-deposition-application head 16, which runs generally transversely, may have an outer face which is more or less flat.

In other embodiments, the dispensing-deposition-application means 8 leads to the proximal wall 16a, or a portion of the proximal wall 16a, in a manner other than medial, for example eccentric or annular or otherwise.

In other embodiments, the outlet opening 13a is arranged not transversely but laterally, the dispensing-deposition-application means 8 being adapted for a lateral discharge of cream.

Thus, depending on the embodiments, the wall or wall portion to which the dispensing-deposition-application means 8 leads, which is shaped to be suitable for the function of dispensing, depositing, applying cream of the dispenser, depositing device, applicator 1 is either the proximal wall 16a, or a portion of the proximal wall 16a, of the dispensing-deposition-application head 16, as illustrated by the figures, in the case of an axial cream discharge, or a portion of the side wall 10a of the first body 10 in the case of a lateral cream discharge.

In general, the dispensing-deposition-application means leads to a wall portion, such as wall 16a or wall 10a, which is free of sharp edges or of areas that would tend to retain cream.

The distal end portion 12 is provided with a transverse mounting opening 15.

The first body/actuation/dispensing-deposition-application assembly 2 next comprises the dispensing-deposition-application head 16 comprising the dispensing-deposition-application means 8.

The dispensing-deposition-application head 16 is mounted so as to slide axially within the first body 10 towards its proximal end portion 11 and, in the embodiment illustrated in the figures, extends axially through the transverse outlet opening 13a. In this embodiment, the transverse outlet opening 13a is shaped according to the lateral contour of the dispensing-deposition-application head 16, which in the embodiment illustrated by the figures is circular, the dispensing-deposition-application head 16 being inscribed within a cylinder with a circular base. However, this embodiment is not exclusive of others in which the lateral contour of the dispensing-deposition-application head 16 may be other than circular, such as oval or polygonal or any other shape combination, the outlet opening 13a, which is transversal, being shaped accordingly while the dispensing-deposition-application head 16 is inscribed within a cylinder having a base other than circular, such as ovoid or polygonal or any other shape combination, or curved or pyramidal, of a simple or more or less convoluted shape.

These embodiments are not exclusive of others in which the dispensing-deposition-application head 16 is mounted so as to slide axially within the first body 10 toward its proximal end portion 11, facing the lateral outlet opening 13a, passing through it or not passing through it, the outlet opening 13a then being axially elongated in correspondence to the axial sliding of the dispensing head 16.

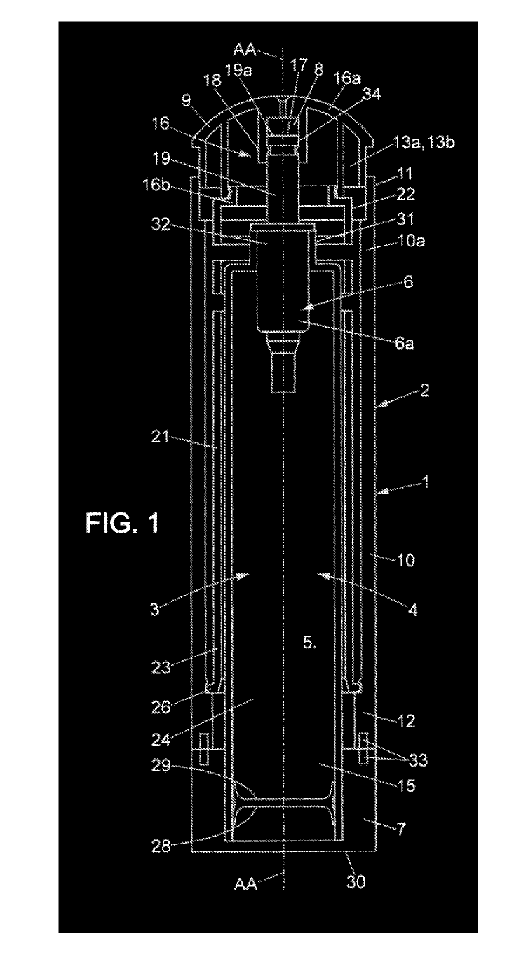

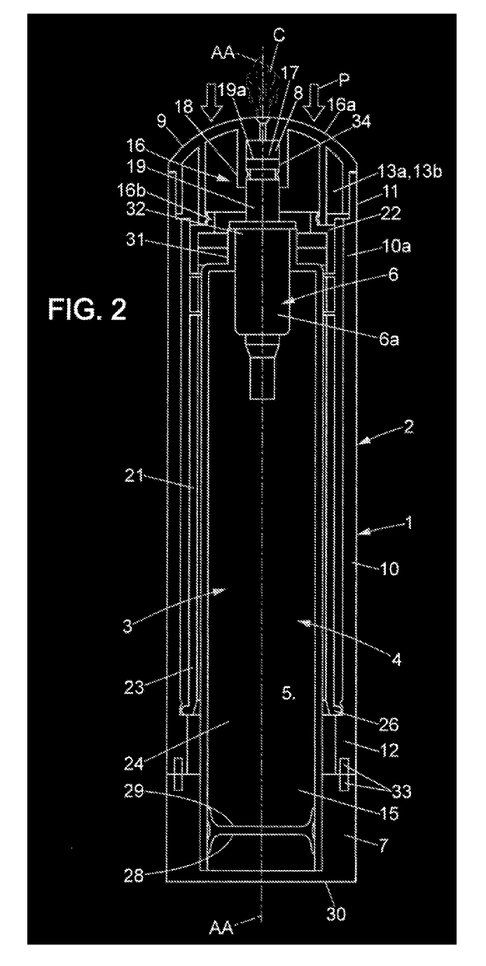

The dispensing-deposition-application head 16 is mounted so as to slide axially between a proximal position (FIG. 1) and a distal position (FIG. 2).

The dispensing-deposition-application head 16 comprises an interior passage 17 having an upstream portion at the top and a downstream portion at the bottom, which in the embodiment illustrated by the drawings, are both generally axially oriented, as is the interior passage 17, to align with an axial cream discharge. This embodiment is not exclusive of one in which the interior passage 17 bends at a right angle or bends similarly, so as to have an upstream axial portion, generally axially oriented, and a downstream radial portion, generally radially oriented, to align with a lateral cream discharge.

The term “radial” refers to that which is or is substantially orthogonal to axis AA.

The terms “upstream” and “downstream” refer to the direction of flow of the cream from the reservoir 5 when dispensed.

Upstream, the interior passage 17 forms or is connected to an upstream distal seat 18, arranged to be able to receive the end connection portion 19a of the actuation tube 19. Thus, either the seat 18 is formed directly by and in the dispensing-deposition-application head 16 or it is formed by means of one or more parts distinct from the dispensing-deposition-application head 16 but connected thereto.

Downstream, the interior passage 17 is connected to the dispensing-deposition-application means, specifically adapted for the dispensing, deposition, application of cream. For example, this means 8 is a tube, nozzle, applicator pad, or brush, this list not being limiting, however, as other equivalent forms are possible for the dispensing, deposition, and application of cream.

The first body/actuation/dispensing-deposition-application assembly 2 next comprises the actuation means 9, movably mounted in the embodiment illustrated by the figures, so as to slide axially relative to the first body 10 towards its proximal end portion 11, facing or through the actuation opening 13b coincident with the outlet opening 13a. In this embodiment, the actuation means 9 is formed by a portion of the dispensing-deposition-application head 16 which the user can actuate, meaning its transverse proximal wall 16a.

This embodiment is not exclusive of others in which the actuation means 9 is movably mounted with pivoting so as to provide an axial movement, or in which the actuation opening 13b is separate from the outlet opening 13a.

The actuation means 9 is mounted so as to be movable between a proximal position (FIG. 1) and a distal position (FIG. 2).

Thus, the actuation means 9 is adapted to be actuated by the user and to move the axially sliding dispensing-deposition-application head 16.

In the embodiment illustrated by the figures, with an axial cream discharge, the discharge end of the dispensing-deposition-application means 8 and the actuation means 9 are more or less coincident or adjacent to one another. This embodiment is not exclusive of others, in particular those with a lateral cream discharge, where the discharge end of the dispensing-deposition-application means 8 and the actuation means 9 are separate and are arranged at least substantially diametrically opposite.

The first body/actuation/dispensing-deposition-application assembly 2 next comprises a resilient means 21, biasing the dispensing-deposition-application head 16 and actuation means 9 towards their proximal position.

When the dispensing-deposition-application head 16 and actuation means 9 are in their distal position, the resilient means 21 is compressed.

The first body/actuation/dispensing-deposition-application assembly 2 next comprises an element for axially guiding the refill 4 during assembly of the portable refillable cream dispenser, depositing device, applicator 1, by connecting the two assemblies 2, 3. This more specifically involves axially guiding the end connection portion 19a of the actuation tube 19 relative to the seat 18 of the dispensing-deposition-application head 16 so as to ensure their correct relative positioning when they are in contact.

In the embodiment shown, the resilient means 21 and the guide element in question are formed by a single part in the form of a guiding tubular spring 21.

The guiding tubular spring 21 is hollow, arranged within the first body 10, extending between a proximal end portion 22 and a distal end portion 23.

The proximal end portion 22 of the guiding tubular spring 21 bears axially on the dispensing-deposition-application head 16 near its distal face 16b and on the actuation means 9. Thus, by its proximal end portion 22, the guiding tubular spring 21 biases the dispensing-deposition-application head 16 and actuation means 9 towards their proximal position.

The distal end portion 23 of the guiding tubular spring 21 is provided with a transverse mounting opening 24.

The guiding tubular spring 21 has a combination of general stability and a capacity to be compressed axially, either because it comprises an axial portion which is axially compressible, for example close to its proximal end 22, or because is compressible as a whole.

Thus, the guiding tubular spring 21 can be axially compressed when the dispensing-deposition-application head 16 and actuation means 9 are in their proximal position.

In the absence of external force on the portable refillable cream dispenser, depositing device, applicator 1, and as represented in FIG. 1, the actuation means 9 and the dispensing-deposition-application head 16 are in their proximal position, thus biased by the guiding tubular spring 21. In this case, the end connection portion 19a of the actuation tube 19 is extended as far as possible from the pump 6a, which is not actuated. There is no dispensing, deposition, or application of cream.

When external force is applied to the portable refillable cream dispenser, depositing device, applicator 1, as a pressure P exerted on the actuation means 9, as illustrated in FIG. 2, the actuation means 9 and the dispensing-deposition-application head 16 are in their distal position, the guiding tubular spring 21 being compressed. In this case, the end connection portion 19a of the actuation tube 19 is retracted as far as possible into the pump 6a, which is actuated. Dispensing, deposition, application of cream occurs, as illustrated in FIG. 2 by a certain amount of cream C.

To carry out the previously mentioned guiding function, the reservoir 5 and the guiding tubular spring 21 respectively have cylindrical outer and inner faces of the same diameter with the clearance necessary for mounting the two assemblies 2 and 3. It is thus that the guiding tubular spring 21 can form an axial guiding element for guiding the refill 4 during assembly of the portable refillable cream dispenser, depositing device, applicator 1 with connection of the two assemblies 2, 3.

In the embodiment represented, the guiding tubular spring 21 extends axially in the distal direction, such that its mounting opening 24 is only slightly distanced axially from the mounting opening 15 of the first body 10, the guiding tubular spring 21 being integrally housed in the first body 10. In one embodiment, the two openings 15 and 24 are located axially adjacent to each other.

It is also provided that the first body 10 and the guiding tubular spring 21 comprise complementary axial locking stops 26. Such stops 26 are suitable for retaining the guiding tubular spring 21 in the first body 10. The tubular spring 21 is thus prevented from being detached from the first body 10. These complementary axial locking stops 26 are located, for example, near the mounting opening 24 of the guiding tubular spring 21 and near the mounting opening 15 of the first body 10.

We will now describe the second body/refill assembly 3, having axis AA.

The second body/refill assembly 3 firstly comprises a rigid second body 7 having a receiving portion 28 intended to receive the distal end portion 29 of the reservoir 5. It also comprises the refill 4.

In the embodiment illustrated by the figures, the second body 7, which forms the base of the portable refillable cream dispenser, depositing device, applicator 1, is short in the axial direction. Where appropriate, it may be heavy and have a flat transverse end face 30. Thus, the portable refillable cream dispenser, depositing device, applicator 1 can remain standing vertically while resting on its transverse end face 30, which is at the bottom, while the proximal dispensing-deposition-application means 8 and actuation means 9 are at the top.

The refill 4 of the second body/refill assembly 3 comprises the reservoir 5 adapted to receive the cream. The reservoir 5, for example made of glass or transparent plastic or in any other desired manner, extends along the axis AA.

The reservoir 5 has an end distal portion 29 of a shape complementary to the receiving portion 28 of the second body 7, so that it can be connected therewith and be supported by it. In the embodiment illustrated by the figures, the reservoir 5 is detachably mounted in the receiving portion 28 of the second body 7.

The reservoir 5 has a proximal end portion 31, with an opening 32 formed in a neck.

To the reservoir 5 is rigidly and inseparably connected, mounted in the outlet opening 32, the means 6 with pump 6a and actuation tube 19 slidably mounted in the pump 6a with an interposed resilient member, and comprising the end connection portion 19a. The actuation tube 19 thus axially extends the reservoir 5 in the proximal direction.

The reservoir 5 and the means 6 with pump 6a and actuation tube 19 together form an inseparable assembly which is a cream refill 4.

The first body/actuation/dispensing-deposition-application assembly 2 and the second body/refill assembly 3 comprise complementary rigid and detachable connection members 33. In the embodiment illustrated by the figures, these rigid and detachable connection members 33 are magnetic and are formed, respectively, on the first body 10 and on the second body 7, for example on their end contact faces, respectively delimiting the mounting opening 15 and the receiving portion 28. This embodiment is not exclusive of other embodiments in which the rigid and detachable connection members 33 may be mechanical, such as a push-turn arrangement, for example a pin and a cutout forming a bayonet-type attachment.

As a result, the first body/actuation/dispensing-deposition-application assembly 2 comprises one of these rigid and detachable connection members 33, and the second body/refill assembly 3, specifically the second body 7, comprises the other of these rigid and detachable connection members 33.

The portable refillable cream dispenser, depositing device, applicator 1 is such that the seat 18 and the connection portion 19a of the actuation tube 19 are connected by mutual contact of their respective contact faces, with sealing means 34.

These sealing means 34 comprise a dimensional adjustment of the respective contact faces of the seat 18 and the connection portion 19a of the actuation tube 19. These sealing means 34 are thus intrinsic to the first body/actuation/dispensing-deposition-application assembly 2, namely the seat 18 of the dispensing-deposition-application head 16, and to the second body/refill assembly 3, namely the end connection portion 19a of the actuation tube 19 of the refill 4.

This contact with dimensional adjustment is suitable for ensuring the required fluidtightness between the seat 18 and the connection portion 18a of the actuation tube 19, where appropriate with the reliefs and/or surface finishes of these contact faces contributing to the fluidtightness.

In addition, said dimensional adjustment is suitable for allowing—during assembly or disassembly of the portable refillable cream dispenser, depositing device, applicator 1—an easy relative axial sliding of said contact faces, when an axial force of assembly or disassembly is exerted that is within the reach of the user, respectively from a relative separated position to a relative contact position or conversely from a relative contact position to a relative separated position.

In the embodiment illustrated by the figures, the respective contact faces of the seat 18 and the connection portion 19a of the actuation tube 19 have a general cylindrical and axial shape. This embodiment is not exclusive of another where these contact faces have a generally flat and transversal shape.

In other embodiments, sealing means are provided which are extrinsic to the first body/actuation/dispensing-deposition-application assembly 2 and to the second body/refill assembly 3.

In some cases, the pump 6a is a mini pump or a larger pump. In one possible embodiment in which the respective contact faces of the seat 18 and the connection portion 19a of the actuation tube 19 have a generally cylindrical and axial shape, these faces have a diameter D larger than the usual diameter of the connection portion of such a pump. For example, with a mini pump 6a, the diameter D can be at least 3.5 mm, more preferably equal to or on the order of 4.2 mm, while the usual diameter of the connection portion of such a pump is equal to 3 mm. This structural arrangement contributes to the effectiveness of the seal.

Depending on the pumps 6a used, the volume of cream obtained by applying pressure to the actuation means 9 may be about 0.08 ml to 0.5 ml.

To assemble the portable refillable dispenser, depositing device, applicator 1, one first obtains the mounted first assembly of body/actuation/spraying 2, the second body 7, and the refill 4. The refill 4 is inserted into the first body 10 through its mounting opening 15 and into the guiding tubular spring 21 through its mounting opening 22, and then is slid axially while being guided by the guiding tubular spring 21, until the end connection portion 19a of the actuation tube 19 and the seat 18 of the spray head 16 are connected by contact, in a fluidtight manner due to the sealing means 34. Lastly, the rigid and detachable connection means 33 are connected.

The portable refillable dispenser, depositing device, applicator 1 is thus assembled. Its disassembly is easy and within the reach of any user, simply by separating the two assemblies 2 and 3, more specifically by separating the rigid and detachable connection means 33. Thus the refill 4 located within the portable refillable dispenser, depositing device, applicator 1 can be removed, and as there are multiple cream refills 4, each for a specific cream, another refill 4 can be mounted in the portable refillable dispenser, depositing device, applicator.

Such a possibility is advantageous in the fields of cosmetic, medical, or functional use, whenever one needs to dispense, deposit, apply different creams with the same portable refillable dispenser, depositing device, applicator 1 without refill.

1-25. (canceled)

26. Portable refillable cream dispenser, depositing device, applicator, complete and assembled, wherein the portable refillable cream dispenser, depositing device, applicator comprises mechanically associated parts so as to be integrally and fluidly attached so that cream in a reservoir can be dispensed, deposited, applied subsequent to maneuvering an actuation means, comprising:
a first body/actuation/dispensing-deposition-application assembly, extending axially, comprising:
a first elongate body having a proximal end portion and a distal end portion with a transverse mounting opening,
a dispensing-deposition-application head mounted so as to slide axially within the first body towards a proximal end portion provided with an outlet opening, with a wall portion to which leads a dispensing-deposition-application means appropriate for dispensing, depositing, applying cream, between a proximal position with no dispensing-deposition-application and a distal position with dispensing-deposition-application, with an interior passage having a distal upstream seat and the proximal downstream dispensing-deposition-application means,
an actuation means mounted so as to be movable relative to the first body towards a proximal end portion provided with an actuation opening, between an inactive proximal position and an active distal position, able to be actuated by the user, with subsequent sliding of the dispensing-deposition-application head,
a resilient means urging the dispensing-deposition-application head and the actuation means towards their proximal position, and capable of being compressed when the dispensing-deposition-application head and the actuation means are in their distal position,
a second body/refill assembly, extending axially, comprising:
a second body,
a refill of cream, comprising: a reservoir having a distal end portion cooperating with a receiving portion of the second body and a proximal end portion with an opening, and a means with pump and actuation tube, which is mounted in the opening of the reservoir, the actuation tube extending the reservoir in the proximal direction and having an end connection portion for connecting with the seat,
the first body/actuation/dispensing-deposition-application assembly and the second body comprising complementary rigid and detachable connection members,
the seat and the connection portion of the actuation tube being connected by mutual contact of respective contact faces, with sealing means.

27. Portable refillable cream dispenser, depositing device, applicator according to claim 26, wherein the first assembly further comprises an element for axially guiding the refill during assembly of the dispenser, depositing device, applicator, in particular for axially guiding the connection portion of the actuation tube relative to the seat of the dispensing-deposition-application head.

28. Portable refillable cream dispenser, depositing device, applicator according to claim 26, wherein the first assembly comprises an elongate tubular spring, arranged in the first body, having a proximal end portion bearing axially against the dispensing-deposition-application head and actuation means, so as to urge them towards their proximal position, and a distal end portion with a transverse mounting opening, the tubular spring and the first body comprising complementary axial locking stops to retain the tubular spring in the first body, the tubular spring having a combination of general stability and a capacity to be compressed axially, allowing the tubular spring to be compressed when the dispensing-deposition-application head and actuation means, are in their proximal position.

29. Portable refillable cream dispenser, depositing device, applicator according to claim 38, wherein the reservoir and the tubular spring respectively have cylindrical outer and inner faces of the same diameter with some clearance for assembly, so as to form an element that axially guides the refill during assembly of the dispenser, depositing device, applicator.

30. Portable refillable cream dispenser, depositing device, applicator according to claim 26, wherein the rigid and detachable connection members of the first assembly are provided on the first body.

31. Portable refillable cream dispenser, depositing device, applicator according to claim 26, wherein the sealing means between the seat of the dispensing-deposition-application head and the connection portion of the actuation tube comprise a dimensional adjustment of their respective contact faces, this contact with dimensional adjustment being suitable for ensuring the required fluidtightness between the seat and the connection portion of the actuation tube, where appropriate with the reliefs and/or surface finishes of the contact faces contributing to the fluidtightness.

32. Portable refillable cream dispenser, depositing device, applicator according to claim 26, wherein the dispensing-deposition-application head with the passage, seat, and dispensing-deposition-application means and actuation means, form a single functional unit axially mounted on the first body, comprising a wall portion (16a) shaped for the dispensing, deposition, application of cream, to which leads, in particular medially, the dispensing-deposition-application means and which forms the actuation means, while the first body comprises a transverse outlet and actuation opening.

33. Portable refillable cream dispenser, depositing device, applicator according to claim 26, wherein the dispensing-deposition-application means leads to a wall portion free of sharp edges and of areas that would tent to retain cream.

34. Portable refillable cream dispenser, depositing device, applicator according to claim 26, wherein the dispensing-deposition-application means is a tube, nozzle, applicator pad, or brush.

35. Portable refillable cream dispenser, depositing device, applicator according to claim 26, wherein the refill comprising the reservoir and the means with pump and actuation tube is detachably mounted in the receiving portion of the second body.

36. Portable refillable cream dispenser, depositing device, applicator according to claim 26, wherein the refill has a capacity of between about 15 ml and about 100 ml.

37. Portable refillable cream dispenser, depositing device, applicator according to claim 26, wherein the reservoir and the means with pump and actuation tube form an inseparable whole which is the cream refill.

38. Portable refillable cream dispenser, depositing device, applicator according to claim 26, wherein the refill is filled with cream.

39. First body/actuation/dispensing-deposition-application assembly, specifically intended for a portable refillable cream dispenser, depositing device, applicator according to claim 26, and for connection to a second body/refill assembly for the latter, comprising, with an axis:
an elongate first body having a proximal end portion and a distal end portion with a transverse mounting opening,
a dispensing-deposition-application head mounted so as to slide axially within the first body towards a proximal end portion thereof provided with an outlet opening, with a wall portion to which leads a dispensing-deposition-application means shaped for the dispensing, deposition, application of cream, between a proximal position with no dispensing-deposition-application and a distal position with dispensing-deposition-application, with an interior passage having a distal upstream seat and the proximal downstream dispensing-deposition-application means,
an actuation means mounted so as to be movable relative to the first body towards a proximal end portion thereof provided with an actuation opening, between an inactive proximal position and an active distal position, able to be actuated by the user, with subsequent sliding of the dispensing-deposition-application head,
a resilient means urging the dispensing-deposition-application head and actuation means towards their proximal position, and capable of being compressed when the dispensing-deposition-application head and actuation means are in their distal position,
a rigid and detachable connection member, complementary to a rigid and detachable connection member of the second body of the second body/refill assembly.

40. First assembly according to claim 39, comprising an axially guiding tubular spring, suitable and intended for axially guiding the refill during assembly of the dispenser, depositing device, applicator, which is axially elongate and arranged within the first body, having a proximal end portion bearing axially against the dispensing-deposition-application head and actuation means, and a distal end portion with a transverse mounting opening, the axially guiding tubular spring and the first body comprising complementary axial locking stops to retain the axially guiding tubular spring in the first body, the axially guiding tubular spring having a combination of general stability and a capacity to be compressed axially, the axially guiding tubular spring extending axially in the distal direction, such that a mounting opening is only slightly distanced axially from the mounting opening of the first body.

41. First assembly according to claim 39, comprising sealing means associated with the seat, for fluidtightness between the seat and the connection portion of the actuation tube, comprising the dimensional adjustment of the contact face of the seat suitable and intended to be in mutual contact with a contact face of the connection portion of the actuation tube, this contact with dimensional adjustment being suitable for ensuring the required fluidtightness between the seat and the connection portion of the actuation tube , where appropriate with the reliefs and/or surface finishes of the contact face of the seat contributing to the fluidtightness.

42. First assembly according to claim 39, wherein the contact face of the seat has a general shape that is either cylindrical and axial or flat and transversal.

43. Second body/refill assembly, specifically intended for the portable refillable cream dispenser, depositing device, applicator, and to be connected to a first body/actuation/dispensing-deposition-application assembly of the dispenser, depositing device, applicator according to claim 39, comprising, with an axis:
a second body having a receiving portion,
a cream refill, comprising: a reservoir having a distal end portion of a shape complementary to the receiving portion and cooperating, in abutment, with the receiving portion of the second body, and a proximal end portion with an opening; and a means with pump and actuation tube, mounted in the opening of the reservoir, the actuation tube extending the reservoir in the proximal direction and having an end connection portion for connecting with a seat of the first body/actuation/dispensing-deposition-application assembly,
a rigid and detachable connection member, complementary to a rigid and detachable connection member of the first body/actuation/dispensing-deposition-application assembly.

44. Portable refillable cream dispenser, depositing device, applicator, without refill, comprising the first body/actuation/dispensing-deposition-application assembly, and a second body suitable and intended to be part of a second body/refill assembly according to claim 43, the first body/actuation/dispensing-deposition-application assembly and the second body being suitable and intended for rigid and detachable interconnection with their complementary rigid and detachable connection members.

45. Dispensing-deposition-application compound assembly, comprising a portable refillable cream dispenser, depositing device, applicator without refill according to claim 44 and a plurality of cream refills, each for a specific cream.
